(19) United States
(12) Patent Application Publication
(10) Pub. No.: US 2019/0101663 A1
(43) Pub. Date: Apr. 4, 2019

(54) Acoustic Imaging For Wellbore Investigation

(71) Applicant: Halliburton Energy Services, Inc., Houston, TX (US)

(72) Inventors: Darren P. Walters, Tomball, TX (US); Ivo Foianini, Humble, TX (US); Kevin S. Harive, Houston, TX (US); Batakrishna Mandal, Missouri City, TX (US); Chung Chang, Houston, TX (US)

(73) Assignee: Halliburton Energy Services, Inc., Houston, TX (US)

(21) Appl. No.: 15/542,812

(22) PCT Filed: Apr. 14, 2016
(86) PCT No.: PCT/US2016/027557

§ 371 Date: Jul. 11, 2017

(51) Int. Cl. G01V 1/50; G01V 1/46; G01V 1/52; E21B 47/14

(52) U.S. Cl. CPC G01V 1/50; E21B 47/14; G01V 1/52; G01V 1/46

(57) ABSTRACT

An acoustic imaging tool, logging system and method are disclosed for producing high-resolution three-dimensional images. The imaging tool may include three separate arrangements of acoustic transducers: a circumferential set for wall inspection, internal transducers for fluid characterization within a chamber open to wellbore fluid, and forward-looking transducers located at the bottom end of the tool. Forward-looking transducers emit ultrasonic waves and receive reflections back when solid features are located under the tool. In some embodiments, Doppler effect calculations may be performed to produce forward-looking acoustic images. In other embodiments, an ambient acoustic energy illuminates the wellbore, and an acoustic lens set focuses reflected ultrasonic waves onto an acoustic imaging array of an ultrasonic camera.

### TECHNICAL FIELD

The present disclosure relates generally to operations performed and equipment used in conjunction with a subterranean well such as a well for recovery of oil, gas, or minerals. Particularly, the disclosure relates to well logging systems and methods, and more particularly, to acoustic imaging.

### BACKGROUND

Well logging systems and methods may be used to inspect and evaluate many characteristics of the wellbore, wellbore casing, and the formations through which the wellbore traverses. Logging tools may include downhole video cameras to allow the operators to see obstructions or well jewelry. However, standard video cameras may require a costly step of pre-conditioning of the well, i.e. bull-heading clear fluids into the area of interest in the well to allow for the video cameras to capture clear images.

### BRIEF DESCRIPTION OF THE DRAWINGS

Embodiments are described in detail hereinafter with reference to the accompanying figures, in which:

FIG. 1A is an elevation view in cross-section of an exemplary well system according to one or more embodiments, showing an acoustic imaging tool deployed within a wellbore;

FIG. 1B is an elevation view in cross-section of an exemplary well system according to one or more embodiments, showing an acoustic imaging tool deployed within a wellbore in a wireline logging environment;

FIG. 1C is an elevation view in cross-section of an exemplary well system according to one or more embodiments, showing an acoustic imaging tool deployed within a wellbore in a logging while drilling (LWD) environment;

FIG. 2 is functional block diagram of a computing system of an acoustic imaging system of FIGS. 1A, 1B, and/or 1C according to one or more embodiments;

FIG. 3A is a simplified axial cross-section of an acoustic imaging tool according to one or more embodiments for use in the well systems of FIGS. 1A, 1B, and/or 1C, showing three independent arrangements of acoustic transponders;

FIG. 3B is a simplified transverse cross-section of the acoustic imaging tool of FIG. 3A taken along lines 3B-3B of FIG. 3A, showing a circumferential array of acoustic transponders;

FIG. 4 is a simplified axial cross-section of an acoustic imaging tool according to one or more embodiments for use in the well systems of FIGS. 1A, 1B, and/or 1C, showing an acoustic illuminator arrangement and an ultrasonic camera selectively positioned at the bottom of the imaging tool;

FIG. 5A is a simplified axial cross-section of an ultrasonic camera according to one or more embodiments of the acoustic imaging tool of FIG. 4, showing an acoustic lens set for focusing ultrasonic waves onto an acoustic imaging array;

FIG. 5B is a transverse cross-section of the ultrasonic camera of FIG. 5A taken along lines 5B-5B of FIG. 5A, showing detail of the acoustic imaging array; and

FIG. 6 is a flowchart of a logging method according to one or more embodiments.

### DETAILED DESCRIPTION

The present disclosure may repeat reference numerals and/or letters in the various examples. This repetition is for the purpose of simplicity and clarity and does not in itself dictate a relationship between the various embodiments and/or configurations discussed. Further, spatially relative terms, such as “beneath,” “below,” “lower,” “above,” “upper,” “uphole,” “downhole,” “upstream,” “downstream,” and the like, may be used for ease in describing relationships illustrated in the figures. The spatially relative terms are intended to encompass different orientations of the apparatus in operation in addition to the orientations disclosed in the specification. In addition, figures are not necessarily drawn to scale but are presented for ease of explanation.

Acoustic imaging tools, logging systems, and logging methods are disclosed that overcome limitations that are inherent with downhole video cameras. By using acoustics to develop high-resolution images, operators will be enabled to see obstructions or well jewelry without the need of conditioning the well. In addition to cost savings from dispensing with the requirement to inject clear fluids into the area of interest in the well, the disclosed imaging tools, systems, and methods also reduce the risk of error, as acoustic sensors will not be directly affected when covered with oil or other opaque well fluid.

As described in greater detail hereinafter, the disclosed acoustic imaging tools may use multiple arrays of acoustic transducers, positioned in different locations within or along the housing to develop images of various perspectives of the wellbore. The returning acoustic waves will be influenced by the presence or absence of material, enabling the generation of pipe amplitude (PAMP) and other images based on the combined responses.

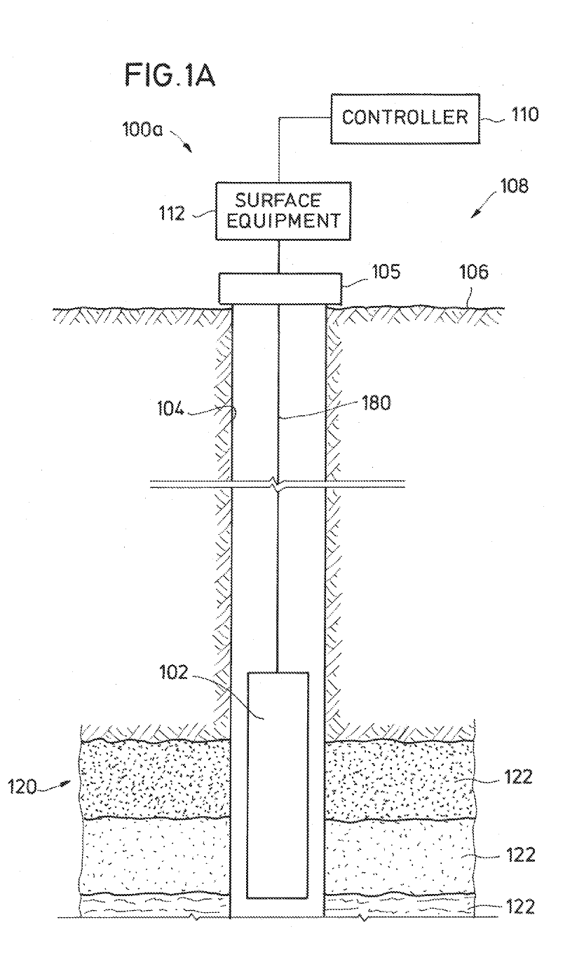

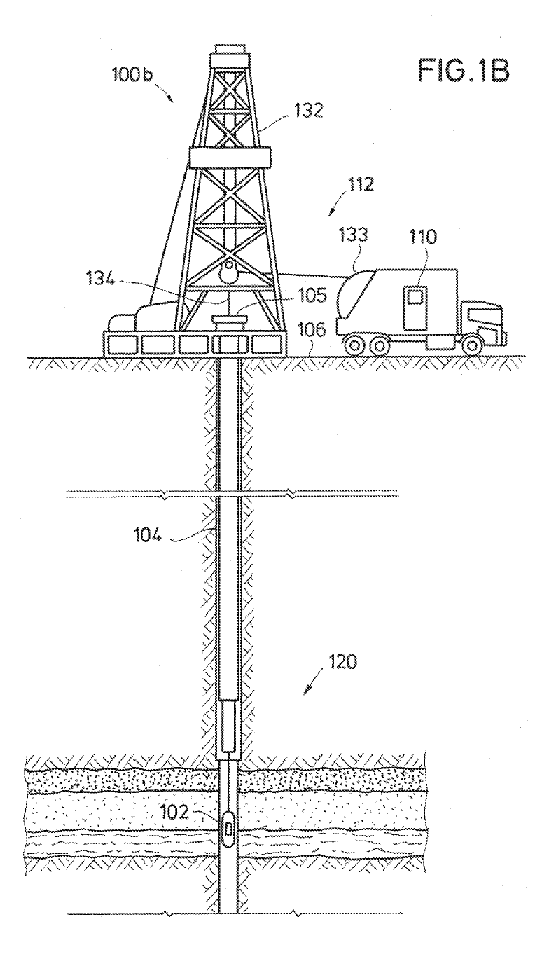

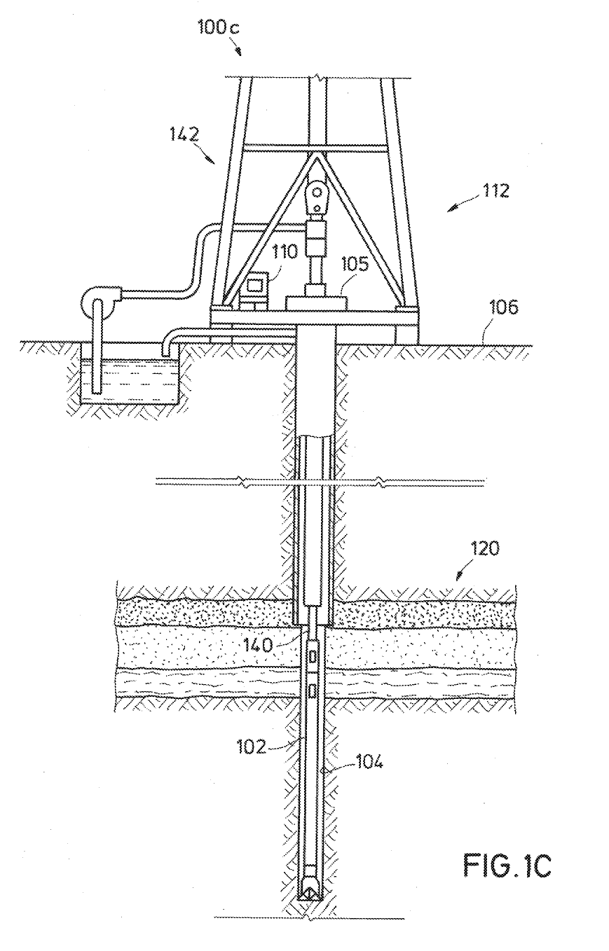

FIG. 1A is a diagram of an exemplary well system 100a. Well system 100a includes a logging system 108 and a subterranean region 120 beneath the ground surface 106. A well system can include additional or different features that are not shown in FIG. 1A. For example, the well system 100a may include additional drilling system components, wireline logging system components, etc.

The subterranean region 120 can include all or part of one or more subterranean formations or zones. The subterranean region 120 shown in FIG. 1A includes multiple subsurface layers 122 and a wellbore 104 penetrating the subsurface layers 122. The subsurface layers 122 can include sedimentary layers, rock layers, sand layers, or combinations of these other types of subsurface layers. One or more of the subsurface layers can contain fluids, such as brine, oil, gas, etc. Although wellbore 104 shown in FIG. 1A is a vertical wellbore, the logging system 108 can be implemented in other wellbore orientations. For example, the logging system 108 may be adapted for horizontal wellbores, slant wellbores, curved wellbores, vertical wellbores, or combinations of these.

The exemplary logging system 108 includes an acoustic imaging tool 102, surface equipment 112, and a tool controller 110. In the example shown in FIG. 1A, acoustic imaging tool 102 is a downhole acoustic imaging tool that operates while disposed in wellbore 104. The example surface equipment 112 shown in FIG. 1A may operate at or above the surface 106, for example, near a well head 105 of wellbore 104, to position acoustic imaging tool 102 and optionally other downhole equipment or other components of the well system 100a. Tool controller 110 may be operable to control surface equipment and to receive and analyze logging data from the acoustic imaging tool 102. Logging system 108 can include additional or different components or features, and such may be arranged and operated as represented in FIG. 1A or in another suitable manner.

In some instances, all or part of tool controller 110 can be implemented as a component of, or can be integrated with one or more components of, the surface equipment 112, the acoustic imaging tool 102, or both. In some cases, tool controller 110 can be implemented as one or more discrete computing system structures separate from surface equipment 112 and acoustic imaging tool 102. In some implementations (not illustrated), controller 110 may be located entirely within acoustic imaging tool 102, and controller 110 and acoustic imaging tool 102 can operate concurrently while disposed in wellbore 104. Although tool controller 110 is shown above surface 106 in the example shown in FIG. 1A, all or part of the tool controller 110 may reside below surface 106, for example, at or near the location of the acoustic imaging tool 102.

Well system 100a can include communication or telemetry equipment that provides a communication link 180 between tool controller 110, acoustic imaging tool 102, and optionally other components of the logging system 108. For example, the components of logging system 108 can each include one or more transceivers or similar apparatus for wired or wireless data communication among the various components. The logging system 108 can include systems and apparatus for wireline telemetry, wired pipe telemetry, mud pulse telemetry, acoustic telemetry, electromagnetic telemetry, or a combination of these other types of telemetry. In some cases, acoustic imaging tool 102 receives commands, status signals, or other types of information from tool controller 110 or another source. In some cases, tool controller 110 receives logging data, status signals, or other types of information from acoustic imaging tool 102 or another source.

Logging operations can be performed in connection with various types of downhole operations at various stages in the lifetime of a well system. Structural attributes and components of surface equipment 112 and acoustic imaging tool 102 can be adapted for various types of logging operations. For example, logging may be performed during drilling operations, during wireline logging operations, or in other contexts. As such, surface equipment 112 and acoustic imaging tool 102 may include, or may operate in connection with drilling equipment, wireline logging equipment, or other equipment for other types of operations.

In some examples, logging operations are performed during wireline logging operations. FIG. 1B shows an exemplary well system 100b that includes acoustic imaging tool 102 in a wireline logging environment. In some example wireline logging operations, surface equipment 112 includes a platform above surface 106 that is equipped with a derrick 132 or a winch 133 that supports a conveyance 134 that extends into wellbore 104. Wireline logging operations can be performed, for example, after a drilling string is removed from wellbore 104 to allow acoustic imaging tool 102 to be lowered by wireline or logging cable into the wellbore 104.

As shown, for example, in FIG. 1B, acoustic imaging tool 102 can be suspended in wellbore 104 by a conveyance 134, which may be a coiled tubing, wireline cable, or another structure that connects the tool to a surface control unit or other components of surface equipment 112. In some implementations, acoustic imaging tool 102 is lowered to the bottom of a region of interest and subsequently pulled upward (e.g., at a substantially constant speed) through the region of interest.

In some examples, logging operations are performed during drilling operations. FIG. 1C shows an exemplary well system 100c that includes acoustic imaging tool 102 in a logging while drilling (LWD) environment. Drilling is commonly carried out using drill pipes connected together to form a drill string 140 that is lowered through a rotary table into wellbore 104. In some cases, a drilling rig 142 at surface 106 supports drill string 140, as drill string 140 is operated to drill a wellbore penetrating subterranean region 120. Drill string 140 may include, for example, a kelly, drill pipe, a bottom hole assembly, and other components. The bottom hole assembly may include drill collars, drill bits, acoustic imaging tool 102, and other components.

Acoustic imaging tool 102 can be deployed in the wellbore 104 on jointed drill pipe, hardwired drill pipe, or other deployment hardware. In some implementations, acoustic imaging tool 102 collects data during drilling operations as it moves downward through the region of interest during drilling operations. In some implementations, acoustic imaging tool 102 collects data while the drilling string 140 is moving, for example, while it is being run in or tripped out of wellbore 104.

In some implementations, acoustic imaging tool 102 collects data at discrete logging points in the wellbore 104. For example, acoustic imaging tool 102 can move upward or downward incrementally to each logging point at a series of depths in wellbore 104. At each logging point, instruments in acoustic imaging tool 102 perform measurements within the wellbore. The measurement data can be communicated to tool controller 110 for storage, processing, and analysis. Such data may be gathered and analyzed during drilling operations (e.g., during LWD operations), during wireline logging operations, or during other types of activities.

Tool controller 110 can receive and analyze the measurement data from acoustic imaging tool 102 to detect and characterize fluid flow, provide images of objects within the wellbore, such as sand, stuck pipe, scale, and characterize the casing inner wall, its dimensions, and the presence or absence of features along the casing wall, as described in greater detail below.

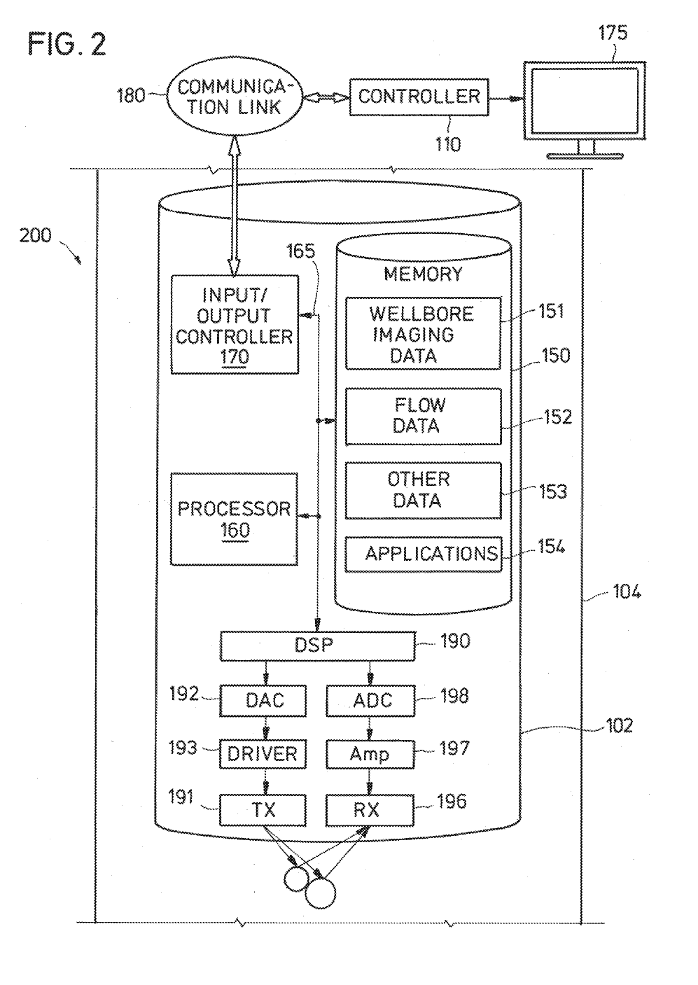

FIG. 2 is a diagram of an exemplary computing system 200 of acoustic imaging tool 102 according to one or more embodiments. Computing system 200 may communicate with tool controller 110 of FIG. 1A. In some cases, computing system 200 may operate in association with a well system (e.g., the well systems 100a, 100b, or 100c shown in FIG. 1A, 1B, or 1C) and may include components located within wellbore 104 or at a remote location. However, all or part of the computing system 200 may operate independently of a well system.

Computing system 200 may include a memory 150, a processor 160, an input/output controller 170, and optionally, a dedicated digital signal processor 190, communicably coupled by a bus 165. Memory 150 can include a random access memory (RAM) and non-volatile flash memory, such as a hard disk, flash memory, or another type of storage medium. Computing system 200 can be preprogrammed or it can be programmed (and reprogrammed) by loading a program from another source (e.g., from a CD-ROM, from another computer device through a data network, or in another manner).

In some examples, input/output controller 170 may be coupled to tool controller 110 via a communication link 180. Input/output controller 170 may also be coupled to other input/output devices 175, such as a monitor, keyboard, mouse, etc., either directly (not illustrated) or via communication link 180 and/or tool controller 110, as illustrated in FIG. 2.

Communication link 180 can include any type of communication channel, connector, data communication network, or other link. For example, communication link 180 can include wireless and/or a wired links (e.g. serial or parallel links) or networks, such as a Local Area Network (LAN), a Wide Area Network (WAN), a private network, a public network (such as the Internet), a WiFi network, a network that includes a satellite link, or another type of data communication network.

Memory 150 can store instructions (e.g., computer code) associated with an operating system, computer applications, and other resources. Memory 150 can also store application data and data objects that can be interpreted by one or more applications or virtual machines running on the computing system 200. As shown in FIG. 2, memory 150 may include wellbore imaging data 151, flow data 152, other data 153, and applications 154. The data and applications in the memory 150 can be stored in any suitable form or format.

Wellbore imaging data 151 can include acoustic measurements and imaging data, as well as other measurements and data acquired by acoustic imaging tool 102 pertaining to objects within wellbore 104 and/or characteristics of the wellbore casing. In some cases, the wellbore imaging data 151 may include one or more measurements for each of multiple different logging points in a wellbore. For example, the logging point associated with a given measurement can be the location of the acoustic imaging tool's reference point when the given measurement was acquired.

Flow data 152 can include information characterizing fluid flow within wellbore 104. For example, the fluid flow travel time may be measured and stored as flow data 152. As with wellbore imaging data 151, flow data 152 may include information associated with one or more logging points.

The other data 153 can include other information that is used by, generated by, or otherwise associated with the applications 154. For example, the other data 153 can include simulated data or other information that can be used to produce acoustic images from the raw acoustic logging data.

The applications 154 can include software applications, scripts, programs, functions, executable code, or other modules that are interpreted or executed by processor 160. For example, applications 154 can include an inversion engine and/or other algorithms to generate a three-dimensional image with proper depth perspective based on logging data. Applications 154 can obtain input data, such as logging data, simulation data, or other types of input data, from memory 150, from another local source, or from one or more remote sources (e.g., via communication link 180). Applications 154 can generate output data and store the output data in memory 150, in another local medium, or in one or more remote devices (e.g., by sending the output data via communication link 180).

Processor 160 can execute instructions, for example, to generate output data based on data inputs. For example, processor 160 can run applications 154 by executing or interpreting the software, scripts, programs, functions, executable code, or other modules contained in applications 154. The input data received by the processor 160 or the output data generated by the processor 160 can include any of wellbore imaging data 151, flow data 152, or other data 153.

In one or more embodiments, digital signal processor (DSP) 190 is a state-of-the-art high-speed semiconductor optimally arranged for efficient processing of digital signals. Acoustic imaging tool 102 may include one or more acoustic transmitters 191 coupled to DSP 190 via a digital-to-analog converter (DAC) 192 and driver circuitry 193. Acoustic transmitters 191 may be driven by predefined sinusoidal or special wavelets generated by DSP 190. Center or operating frequency of the driving signal may be defined by the speed of acoustic imaging tool 102 travelling within wellbore 104, borehole fluid attenuation, and desired resolution of the image to be generated. In one or more embodiments, center frequency may range between 50 kHz and 250 kHz, although frequencies outside this range may be used as appropriate.

Acoustic imaging tool 102 may include one or more acoustic receivers 196 coupled to DSP 190 via amplifier circuitry 197 and an analog-to-digital converter (ADC) 198, which will acquire acoustic signals with variable gain and digitize the signals for time-frequency analysis. In one or more embodiments, ADC 198 will sample at a rate of 2 MHz or greater.

Although optional DSP 190 is described as operable to generate driving signals and analyze received signals and FIG. 2 illustrates DSP 190 as coupled to acoustic transmitters 191 and acoustic receivers 196, in one or more embodiments, processor 160 may perform this role in lieu of DSP 190. Additionally, multiple acoustic transmitters 191 and receivers 196 may be included in one or multiple transmission and reception channels, with one or more driver circuits 193, one or more amplifier circuits 197, one or more DACs 192, one or more ADCs 199, and one or more DSPs 190. Moreover, although FIG. 2 illustrates separate acoustic transmitters 191 and acoustic receivers 196, one or more combined acoustic transducers that both transmit and receive (not illustrated) may be used as appropriate in lieu of separate transmitters and receivers.

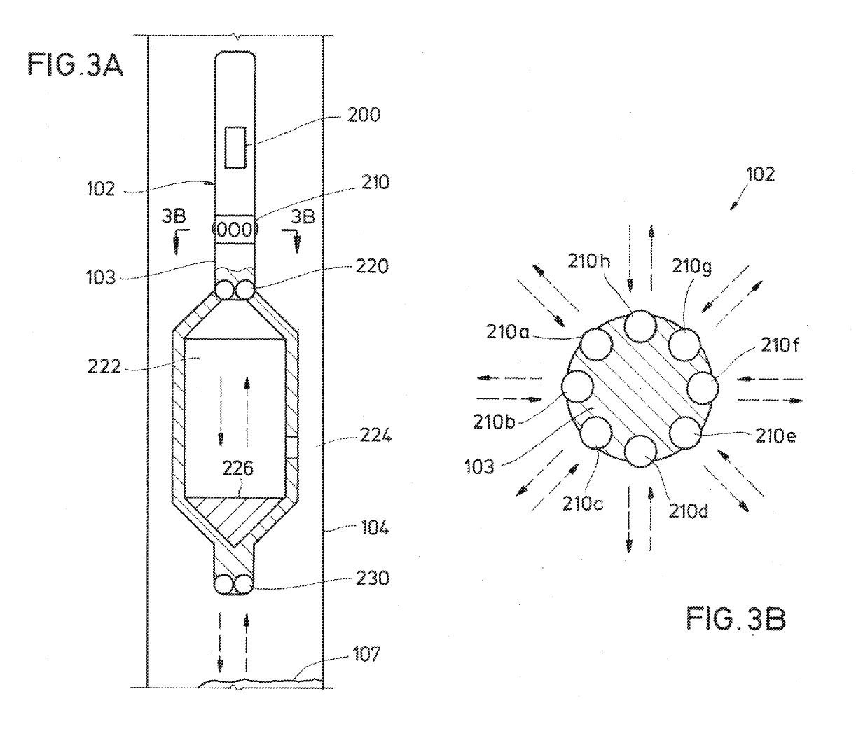

FIGS. 3A and 3B are simplified axial and transverse cross-sections, respectively, that illustrate acoustic imaging tool 102 according to one or more embodiments. Acoustic imaging tool 102 may include three separate arrangements of acoustic transducers: a circumferential set 210 for wall inspection, one or more internal transducers 220 for fluid characterization, and one or more forward-looking transducers 230 located at the bottom end of acoustic imaging tool 102. Transducers 210, 220, and 230 may each correspond with a transmitter 191 and a receiver 196 of FIG. 2. The multi-transducer design of acoustic imaging tool 102 of FIGS. 3A and 3B may have multiple applications, as described below.

In one or more embodiments, transducer set 210 includes a radial array of side-looking ultrasonic transducers 210a-210h positioned circumferentially around a housing 103 of acoustic tool 102, preferably with equally-spaced angular separations. This side-looking circumferential arrangement allows transducer set 210 to characterize the pipe inner wall from a side-view perspective. In one or more embodiments, eight transducers 210 are provided, although a greater or lesser number of transducers 210 may be used as appropriate. Transducer array 210, located circumferentially about the tool's outside diameter, may optionally supplement either or both of the transducer arrays 220, 230, described below, being either used to further characterize fluid flow from a side view perspective, to characterize the pipe inner wall and its dimensions, and/or verify the presence or absence of certain features within wellbore 104.

In one or more embodiments, one or more transducers 220 may be located on a first end of a chamber 222. Chamber 222 may include a target 226 at a second end, which may be located about twelve inches or other appropriate distance from transducers 220. Chamber 222 may include one or more ports 224 allowing fluid communication between chamber 222 and the interior of wellbore 104. Transducer 220 may emit an ultrasonic wave that reflects back from target 224, thereby allowing characterizing wellbore fluid within chamber 222. Chamber 222, transducer 220, and target 226 may be primarily used to characterize fluid flow, providing an image of accompanying information, such as fluid travel time measurement within the well fluid, for production logging-related uses.

In one or more embodiments, transducer 230 (or transducer array, if desired) may be located under chamber 222 and oriented so as to point downwards (i.e., forwards) in order to emit ultrasonic waves and receive reflections back when solid features are located beneath acoustic imaging tool 102. Transducer 230 provides for generation of images without the need of a target. Transducer(s) 230 may be primarily used for pipe recovery, plugging and abandonment, and well intervention applications, including the determination of where a solid component in the well (e.g., sand, stuck pipe, cut wire, scale, etc.) may be located.

As noted above with respect to FIG. 2, computing system 200 includes the appropriate electronics and algorithms to generate a three-dimensional image of the pipe interior with the proper depth perspective, based on the combination of the images generated by the three transducer arrangements 210, 220, 230. This process essentially eliminates from produced images the presence of the lower housing of acoustic imaging tool 102 where the bottom-facing transducer(s) 230 is located.

In one or more embodiments, computing system 200 may employ an algorithm that accumulates the various Doppler frequency shift measurements from transducers 230 and projects in the space domain a constructed wellbore image with the wellbore fluid velocity and the speed of acoustic imaging tool 102 within wellbore 104. The frequency shift at a given moment in time may be used to determine the position and velocity of a given moving object, and the intensity of the signal at that given moment in time is indicative of the type of reflector.

Doppler Effect is the measurement of frequency shift of a predefined applied wave field from a moving object relative to an observer. In this case, any moving object could be considered, including both the acoustic imaging tool 102, and other objects—both static (e.g., wellbore wall) and dynamic (e.g., gas bubble or multi-phase fluid flow). Assuming an acoustic wave (preferably, mono-frequency (f₀)) is transmitted by an acoustic transmitter 191 (FIG. 2), then the frequency of the received signal from a single-point reflector/scatterer is given as:

$$f = {f}_{0} ( 1 + \frac{2 ( {v}_{s} - {v}_{0} )}{{v}_{m}} ) , \qquad ( Eq . 1 )$$

where vₛ is the velocity of the scatterer, v₀ is the velocity of acoustic imaging tool 102, and vₘ is the acoustic velocity of the medium (borehole fluid). Accordingly, if vᵣ=(vₛ−v₀) signifies the relative velocity of the scatterer relative to acoustic imaging tool 102, the measurement of Doppler frequency shift Δf from f₀ may be given as:

$$Δ f = f - {f}_{0} = {f}_{0} \frac{2 {v}_{r}}{{v}_{m}} . \qquad ( Eq . 2 )$$

The frequency shift measurement Δf may be used to construct an acoustic image from tool movement or/and scatterer properties.

Doppler diagnostic frequency may be the time-dependent frequency shift in the case of considering the multi-frame of a moving object. The relationship of multiple time-dependent Doppler frequency shifted components f_{D} may be expressed as:

$${f}_{D} ( t ) = {f}_{0} {\sum }_{i} {\sum }_{j} ( 1 + \frac{2 ( {v}_{s} ( i ) - {v}_{0} ( j ) )}{{v}_{m}} ) \qquad ( Eq . 3 )$$

Time-dependent Doppler frequency shifted components may be mapped in space in image form to identify the borehole characteristics using the wellbore fluid velocity and the acoustic imaging tool velocity. The variable i denotes various reflectors with different velocities, and the variable j denotes the variable tool velocities. Estimation of the different Doppler shifts with time may be calculated using a short-time Fourier transform (STFT) technique or any other multivariate signal processing technique. For simple applications, the STFT of the receive signals (x(t)) may be computed with a sliding window (w(t)) (e.g., a Hamming window). A two dimensional map (t,f) may be constructed as:

STSF(t,f)=∫x(t+τ)w(τ)e^{-i2πfτ}dτ (Eq. 4)

This time-frequency map for each received signal may be used to map the object beneath acoustic imaging tool 102. This technique may be used, for example, to monitor gas bubble movement or fluid leaks from the wellbore wall, for both dynamic and static measurements.

In one or more embodiments, arrays of transmitters 191 and receivers 196 (FIG. 2) may be used to form a directional beam (e.g. phased array method) to image a particular direction of wellbore 104. Advanced beam-forming techniques may also be used to image wellbore 104 from the observed waveforms. Note that, the Doppler effect technique uses a different domain (i.e., frequency shift), and it may provide an advantage with noisy signals.

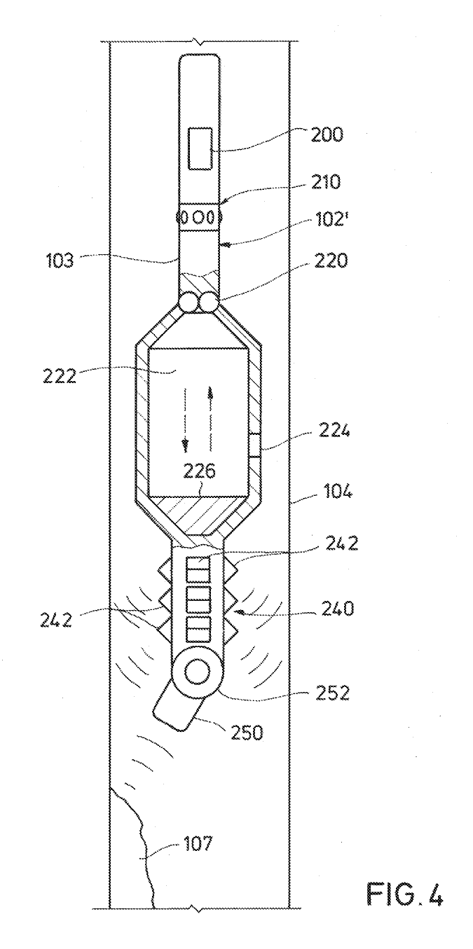

FIG. 4 is a simplified axial cross-section of an acoustic imaging tool 102′ according to one or more embodiments. As with acoustic imaging tool 102 of FIGS. 3A and 3B, acoustic imaging tool 102′ of FIG. 4 may optionally include a circumferential set of acoustic transducers 210 for wall inspection and one or more internal transducers 220, chamber 222, and target 226, for fluid characterization. However, the forward-looking Doppler-effect transducers 230 located at the bottom end of acoustic imaging tool 102 may be replaced by one or more acoustic transducers defining an acoustic illuminator arrangement 240 and an ultrasonic camera 250.

As illustrated in FIG. 4, in one or more embodiments acoustic illuminator arrangement 240 may include a circumferential arrangement of ultrasonic transmitters 242 that provide an ambient level of acoustic energy within wellbore 104 below acoustic imaging tool 102′. Acoustic waves may reflect from the wall surface of wellbore 104 or an object 107 located within wellbore 104 and be detected and transformed into an image by ultrasonic camera 250. Ultrasonic camera 250 may be pivotally mounted to the body of acoustic imaging tool 102′, such as on a gimbal 252. Ultrasonic camera 250 may thereby be selectively positioned via an actuator (not illustrated) and coupled to tool controller 110 (FIG. 1A) so as to allow the operator to direct the camera to view in a particular direction.

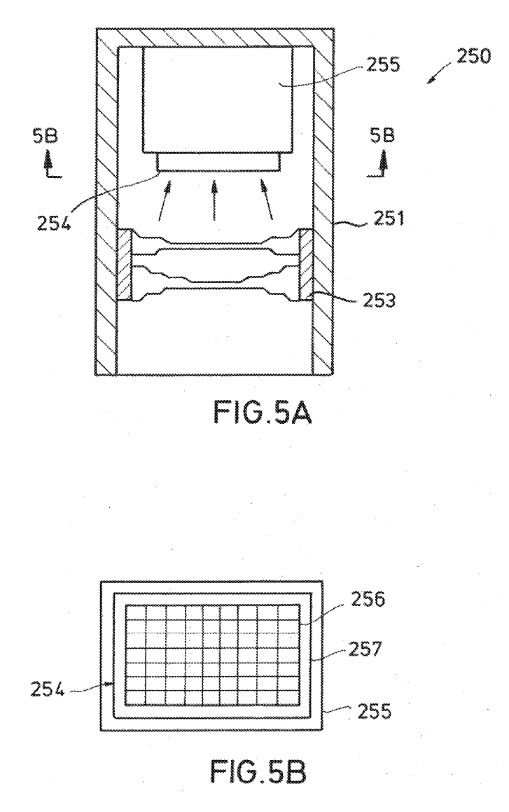

FIG. 5A is an axial cross-section of ultrasonic camera 250 of FIG. 4 according to one or more embodiments. Ultrasonic camera 250 may include a case 251 mounted to acoustic imaging tool 102′, such as on gimbal 252 (FIG. 4). Case 251 may house an acoustic lens set 253, an ultrasound imaging array 254, and a processing circuitry module 255. Acoustic lens set 253 (which may consist of one or more acoustic lenses) operates in an analogous fashion to an optical lens set to focus incoming ultrasonic sound waves onto imaging array 254. Acoustic illuminator assembly 240, acoustic lens set 253, imaging array 254, and ultrasonic camera 250 may be commercially available from Imperium, Inc.

FIG. 5B is a transverse cross-section of ultrasonic camera 250 taken along lines 5B-5B of FIG. 5A. Imaging array 254 may include a layer of piezoelectric material 256 formed upon a readout integrated circuit (ROIC), which may be electrically coupled to processing circuitry module 255 via a pin grid array package 257 or similar arrangement. Processing circuitry module 255 may include preamplifiers and detection, signal conditioning, and multiplexing circuitry, for example.

Referring to FIG. 4-5B, the acoustic imaging concept of ultrasonic camera 250 is similar to an optical camera, except that it uses acoustic waves rather than light waves. Ultrasonic camera 250 does not require a coherent acoustic source so long as the target is illuminated by acoustic energy (supplied by acoustic illuminator arrangement 240) and there are reflected acoustic signals returning from a target. An image is formed by using acoustic lens set 253 to focus the shape of the target at focal plan into a large pixelated array of ultrasonic receivers formed by imaging array 254. The received acoustic signals at each of the receiver pixels may be converted to gray scale output of varying intensities to form an image of the target with contrast. In this manner, real-time acoustic images can be captured like a video camera.

Because the technology employed by ultrasonic camera 250 is different from the pulse-echo forward-looking technique of acoustic transducer 230, the acoustic illuminator arrangement 240 can be located above the ultrasonic camera 250 so long as there is sufficient acoustic energy to illuminate the target ahead of acoustic imaging tool 102′. Because there is no coherence source requirement, each transmitter 242 of acoustic illuminator arrangement 240 can transmit at different frequencies. Moreover, without transmitters 242 being disposed at the head (bottom) of acoustic imaging tool 102′, a larger acoustic lens set 253 may be used to improve the imaging resolution.

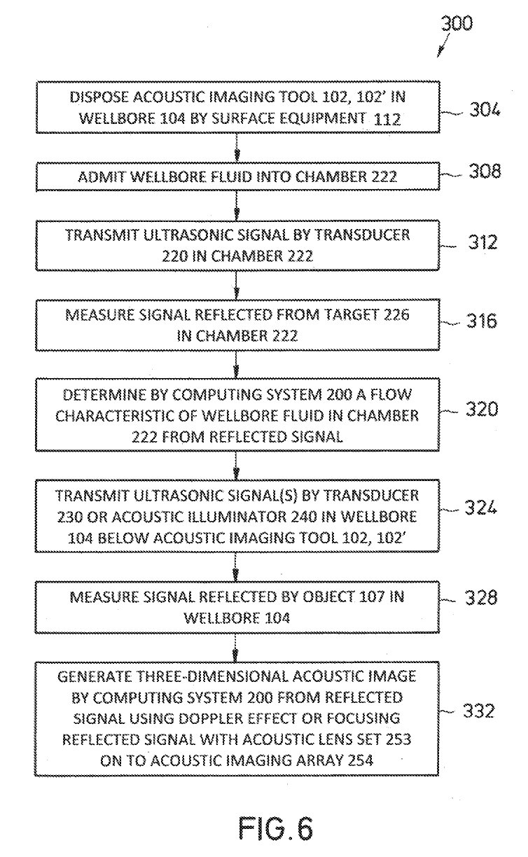

FIG. 6 is a flowchart of a logging method 300 according to one or more embodiments using logging system 108 (FIGS. 1A-1C) with acoustic imaging tool 102 of FIG. 3A or acoustic imaging tool 102′ of FIG. 4. Although shown preceding steps 308-320, steps 324-332 may also be performed concurrently with or following steps 324-332. Additionally, other steps not illustrated may also be performed within logging method 300, for example, logging operations associated with side-looking transducers 210, as described further below.

Referring to FIGS. 1A-1C and 6, at step 304, acoustic imaging tool 102 or 102′ may be disposed and selectively positioned within wellbore 104 by service equipment 112. Surface equipment 112 may be logging equipment, such as illustrated and described above with respect to FIG. 1B, or logging while drilling equipment, such as illustrated and described above with respect to FIG. 1C. That is, acoustic imaging tool 102, 102′ may be carried by coiled tubing or logging cable 134, or by drill string 140, and selectively positioned into wellbore 104 using derrick 132, winch 133, or drilling rig 142. Logging operations may be performed at various locations within wellbore 104 and while moving acoustic imaging tool 102, 102′ within the wellbore.

Steps 308-320 pertain to determining one or more fluid characteristics using acoustic transducer(s) 220, chamber 222, and target 226. Referring to FIGS. 3A or 4, and 6, at step 308, wellbore fluid is admitted into chamber 222 via port 224. In one or more embodiments, port 224 may be a valved port, controlled by tool controller 110, to allow selective and isolable fluid communication with wellbore 104. In other embodiments port 224 may be always open. Additional ports may also be provided to facilitate chamber fluid ingress and egress.

At steps 312-320, and ultrasonic signal is transmitted by transducer 220 and propagates to chamber 222, reflects off of target 226, and is received at transducer 220. Computing system 200 uses the reflected ultrasonic signal received at transducer 222 determine one or more characteristics of the fluid within chamber 222. For example, fluid travel time measurement within wellbore 104 may be determined, and an acoustic image of the fluid within chamber 222 may be generated.

Steps 324-332 pertain to generating forward-looking three-dimensional acoustic images of wellbore 104 below acoustic imaging tool 102, 102′. Referring to FIGS. 3A and 6, in one or more embodiments, acoustic transducer 230 transmits an ultrasonic signal below acoustic imaging tool 102. The acoustic signal may reflect off of an object 107 located within the wellbore and be received at acoustic transducer (or transducer array) 230. As described above with respect to Equations 1-4, computing system 200 may employ an algorithm that accumulates the various Doppler frequency shift measurements from transducers 230 and projects in the space domain a constructed wellbore image with the wellbore fluid velocity and the speed of acoustic imaging tool 102 within wellbore 104. The frequency shift at a given moment in time is determinative of the position and velocity of a given moving object, and the intensity of the signal at that given moment in time is indicative of the type of reflector. Computing system 200 may thereby generate from the reflected signals a forward-looking three-dimensional acoustic image of wellbore 104 below acoustic imaging tool 102.

Although not illustrated in FIG. 6, in one or more embodiments, acoustic imaging tool 120 may also include a circumferential arrangement of acoustic transducers 210, which transmit and receive reflected acoustic signals that may be processed by computing system 200 to produce acoustic images of the sides of wellbore 104.

Referring to FIGS. 4 and 6, in one or more embodiments of steps 324-332, acoustic illumination assembly 240 may be used to provide an ambient level of acoustic energy in wellbore 104 below acoustic imaging tool 102′. Acoustic waves may reflect from object 107 located below acoustic imaging tool 102′ and be received by ultrasonic camera 250. Ultrasonic camera 250 may include acoustic lens set 253 which focuses ultrasonic waves onto acoustic imaging array 254. The pixelated acoustic imaging array 254 may be coupled to processing circuitry 255 to generate high-resolution three-dimensional acoustic images of wellbore 104 below acoustic imaging tool 102′.

Acoustic camera 250 may be mounted to housing 103 of acoustic imaging tool 102′ using a gimbal 252 or similar pivotal arrangement so as to be selectively positionable to view both below acoustic imaging tool 102′ and the sides of wellbore 104. In such an arrangement, a separate circumferential array of transducers 210 for side wall inspection may not be necessary. However, it may nevertheless be desirable to provide such a separate circumferential array of acoustic transducers 210 for continuous and rapid inspection of the sides of wellbore 104 independently from ultrasonic camera 250.

Acoustic imaging tools 102, 102′ and logging method 300 provide superior performance to traditional downhole video cameras, with virtually no imaging drawbacks. Acoustic imaging tools 102, 102′ can generate high resolution images with reduced adverse fluid effects, resulting in more clear and contrasting images of what may be located inside wellbore 104. According, more informed decisions may be made for solving the problems such as stuck pipe, sanded perforations, et cetera.

In summary, a downhole acoustic imaging tool, a logging system to produce images of a wellbore, and a logging method have been described. Embodiments of a downhole acoustic imaging tool may generally have: a housing; a chamber in fluid communication with an exterior of the housing; a first acoustic transducer disposed at a first end of the chamber; a target disposed at a second end of the chamber; and at least one forward-looking second acoustic transducer disposed at a bottom end of the housing. Embodiments of a logging system to produce images of a wellbore may generally have: an acoustic imaging tool; and surface equipment carrying the acoustic imaging tool and operable to selectively position set acoustic imaging tool within the wellbore; the acoustic imaging tool including a chamber in fluid communication with the wellbore, a first acoustic transducer disposed at a first end of the chamber, a target disposed at a second end of the chamber, and at least one forward-looking second acoustic transducer disposed at a bottom end of the housing. Embodiments of a logging method may generally include: disposing an acoustic imaging tool within the wellbore; admitting fluid from the wellbore into a chamber; transmitting a first ultrasonic signal through the fluid and the chamber; measuring a first reflection of the first ultrasonic signal and the chamber; determining a characteristic of the fluid from the first reflection; transmitting a second ultrasonic signal into the wellbore below the acoustic imaging tool; measuring a second reflection of the second ultrasonic signal; and generating a three-dimensional forward-looking acoustic image of the wellbore from the second reflection.

Any of the foregoing embodiments may include any one of the following elements or characteristics, alone or in combination with each other: a radial array of side-looking acoustic transducers circumferentially disposed about the housing; a computing system coupled to the first acoustic transducer, the at least one forward-looking second acoustic transducer, and the radial array of side-looking acoustic transducers, the computing system operable to determine a characteristic of a fluid within the chamber and to generate forward-looking and side-looking acoustic images; a computing system coupled to the first acoustic transducer and the at least one forward-looking second acoustic transducer, the computing system operable to determine a characteristic of a fluid within the chamber and to generate forward-looking acoustic images using a Doppler effect; the at least one forward-looking second acoustic transducer includes an acoustic illuminator arrangement and an ultrasonic camera; the acoustic illuminator arrangement includes a plurality of ultrasonic transmitters circumferentially disposed about the housing; the ultrasonic camera includes an acoustic lens set arranged to focus acoustic energy onto an acoustic imaging array; the ultrasonic camera is pivotally mounted to the housing and selectively positionable; the computing system is operable to generate forward-looking and side-looking three-dimensional acoustic images; the computing system is operable to generate forward-looking acoustic three-dimensional images using a Doppler effect; a radial array of side-looking acoustic transducers circumferentially disposed about the housing; a computing system coupled to the first acoustic transducer, the at least one forward-looking second acoustic transducer, and the radial array of side-looking acoustic transducers, the computing system operable to determine a characteristic of a fluid within the chamber and to generate forward-looking and side-looking three-dimensional acoustic images; a computing system coupled to the first acoustic transducer and the at least one forward-looking second acoustic transducer, the computing system operable to determine a characteristic of a fluid within the chamber and to generate forward-looking three-dimensional acoustic images using a Doppler effect; the at least one forward-looking second acoustic transducer includes an acoustic illuminator arrangement and an ultrasonic camera; the acoustic illuminator arrangement includes a plurality of ultrasonic transmitters circumferentially disposed about the housing; the ultrasonic camera includes an acoustic lens set arranged to focus acoustic energy onto an acoustic imaging array; the ultrasonic camera is pivotally mounted to the housing and selectively positionable; a conveyance carrying the acoustic imaging tool selected from the group consisting of a coiled tubing and a wireline cable; at least one of the group consisting of a winch and a derrick operable to deploy the conveyance and set acoustic imaging tool within the wellbore; the surface equipment includes a drilling rig carrying a drill string; set acoustic imaging tool is carry along the drill string as part of a bottom hole assembly; transmitting a third ultrasonic signal into the wellbore about a circumference of the acoustic imaging tool; measuring a third reflection of the third ultrasonic signal; generating a three-dimensional side-looking acoustic image of the wellbore from the third reflection; computing a Doppler effect from the second reflection; generating an ambient acoustic energy below the acoustic imaging tool; focusing the second reflection on to an acoustic imaging array; generating the ambient acoustic energy by a circumferential array of ultrasonic transmitters; focusing the second reflection by an acoustic lens set; and selectively positioning the acoustic lens set and the acoustic imaging array with respect to a housing of the acoustic imaging tool.

The Abstract of the disclosure is solely for providing a way by which to determine quickly from a cursory reading the nature and gist of technical disclosure, and it represents solely one or more embodiments.

While various embodiments have been illustrated in detail, the disclosure is not limited to the embodiments shown. Modifications and adaptations of the above embodiments may occur to those skilled in the art. Such modifications and adaptations are in the spirit and scope of the disclosure.

What is claimed:

1. A downhole acoustic imaging tool, comprising:
a housing;
a chamber in fluid communication with an exterior of said housing;
a first acoustic transducer disposed at a first end of said chamber;
a target disposed at a second end of said chamber; and
at least one forward-looking second acoustic transducer disposed at a bottom end of said housing.

2. The imaging tool of claim 1 further comprising:
a radial array of side-looking acoustic transducers circumferentially disposed about said housing.

3. The imaging tool of claim 2 further comprising:
a computing system coupled to said first acoustic transducer, said at least one forward-looking second acoustic transducer, and said radial array of side-looking acoustic transducers, said computing system operable to determine a characteristic of a fluid within said chamber and to generate forward-looking and side-looking acoustic images.

4. The imaging tool of claim 1 further comprising:
a computing system coupled to said first acoustic transducer and said at least one forward-looking second acoustic transducer, said computing system operable to determine a characteristic of a fluid within said chamber and to generate forward-looking acoustic images using a Doppler effect.

5. The imaging tool of claim 1 wherein:
said at least one forward-looking second acoustic transducer includes an acoustic illuminator arrangement and an ultrasonic camera.

6. The imaging tool of claim 5 wherein:
said acoustic illuminator arrangement includes a plurality of ultrasonic transmitters circumferentially disposed about said housing; and
said ultrasonic camera includes an acoustic lens set arranged to focus acoustic energy onto an acoustic imaging array.

7. The imaging tool of claim 5 wherein:
said ultrasonic camera is pivotally mounted to said housing and selectively positionable.

8. The imaging tool of claim 3 wherein:
said computing system is operable to generate forward-looking and side-looking three-dimensional acoustic images.

9. The imaging tool of claim 4 further comprising:
said computing system is operable to generate forward-looking acoustic three-dimensional images using a Doppler effect.

10. A logging system to produce images of a wellbore, comprising:
an acoustic imaging tool; and
surface equipment carrying said acoustic imaging tool and operable to selectively position set acoustic imaging tool within said wellbore;
said acoustic imaging tool including,
a chamber in fluid communication with said wellbore,
a first acoustic transducer disposed at a first end of said chamber,
a target disposed at a second end of said chamber, and
at least one forward-looking second acoustic transducer disposed at a bottom end of said housing.

11. The logging system of claim 10 wherein said acoustic imaging tool further comprises:
a radial array of side-looking acoustic transducers circumferentially disposed about said housing.

12. The logging system of claim 11 wherein said acoustic imaging tool further comprises:
a computing system coupled to said first acoustic transducer, said at least one forward-looking second acoustic transducer, and said radial array of side-looking acoustic transducers, said computing system operable to determine a characteristic of a fluid within said chamber and to generate forward-looking and side-looking three-dimensional acoustic images.

13. The logging system of claim 10 wherein said acoustic imaging tool further comprises:
a computing system coupled to said first acoustic transducer and said at least one forward-looking second acoustic transducer, said computing system operable to determine a characteristic of a fluid within said chamber and to generate forward-looking three-dimensional acoustic images using a Doppler effect.

14. The logging system tool of claim 10 wherein:
said at least one forward-looking second acoustic transducer includes an acoustic illuminator arrangement and an ultrasonic camera.

15. The logging system of claim 14 wherein:
said acoustic illuminator arrangement includes a plurality of ultrasonic transmitters circumferentially disposed about said housing; and
said ultrasonic camera includes an acoustic lens set arranged to focus acoustic energy onto an acoustic imaging array.

16. The logging system of claim 14 wherein:
said ultrasonic camera is pivotally mounted to said housing and selectively positionable.

17. The logging system of claim 10 wherein said surface equipment comprises:
a conveyance carrying said acoustic imaging tool selected from the group consisting of a coiled tubing and a wireline cable; and
at least one of the group consisting of a winch and a derrick operable to deploy said conveyance and set acoustic imaging tool within said wellbore.

18. The logging system of claim 10 wherein:
said surface equipment includes a drilling rig carrying a drill string; and
set acoustic imaging tool is carry along said drill string as part of a bottom hole assembly.

19. A logging method, comprising:
disposing an acoustic imaging tool within said wellbore;
admitting fluid from said wellbore into a chamber;
transmitting a first ultrasonic signal through said fluid and said chamber;
measuring a first reflection of said first ultrasonic signal and said chamber;
determining a characteristic of said fluid from said first reflection;
transmitting a second ultrasonic signal into said wellbore below said acoustic imaging tool;
measuring a second reflection of said second ultrasonic signal; and
generating a three-dimensional forward-looking acoustic image of said wellbore from said second reflection.

20. The method of claim 19 further comprising:
transmitting a third ultrasonic signal into said wellbore about a circumference of said acoustic imaging tool;
measuring a third reflection of said third ultrasonic signal; and
generating a three-dimensional side-looking acoustic image of said wellbore from said third reflection.

21. The method of claim 19 wherein generating said forward-looking acoustic image further comprises:
computing a Doppler effect from said second reflection.

22. The method of claim 19 wherein generating said forward-looking acoustic image further comprises:
generating an ambient acoustic energy below said acoustic imaging tool; and
focusing said second reflection on to an acoustic imaging array.

23. The method tool of claim 22 further comprising:
generating said ambient acoustic energy by a circumferential array of ultrasonic transmitters; and
focusing said second reflection by an acoustic lens set.

24. The method of claim 23 further comprising:
selectively positioning said acoustic lens set and said acoustic imaging array with respect to a housing of said acoustic imaging tool.
